(19) United States
(12) Patent Application Publication
(10) Pub. No.: US 2014/0278579 A1
(43) Pub. Date: Sep. 18, 2014

(54) Medical Form Generation, Customization and Management

(71) Applicant: Hamed Mojahed, Nashville, TN (US)

(72) Inventor: Hamed Mojahed, Nashville, TN (US)

(21) Appl. No.: 14/208,424

(22) Filed: Mar. 13, 2014

Related U.S. Application Data
(60) Provisional application No. 61/791,307, filed on Mar. 15, 2013.

(51) Int. Cl. G06F 19/00

(52) U.S. Cl. CPC G06F 19/328; G06Q 40/08
USPC 705/4

(57) ABSTRACT

The present invention provides for a computer-implemented method for controlling the generation, customization and management of medical forms, the method comprising receiving current patient identification information, receiving a selection of a medical procedure provided to the current patient for which a medical insurance claim is to be submitted to the current patient's medical insurance provider, identifying one or more individual medical forms required for the medical insurance claim to be submitted to the current patient's medical insurance provider, displaying a sextant image relevant to the selected medical procedure, receiving positional information from a selection made on the displayed sextant image and generating the identified one or more medical forms such that the generated medical forms are automatically populated with the received identification information and the received positional information.

### CROSS-REFERENCE TO RELATED APPLICATIONS

This application claims the benefit of U.S. Provisional Application No. 61/791,307, filed on Mar. 15, 2013, in the name of Hamed Mojahed, the disclosure of which is incorporated herein by reference.

### FIELD OF THE INVENTION

The present invention relates to a system and method for generating, customizing and managing medical forms, the system and method helping to ensure that medical forms generated, customized and managed by a medical practice fulfill the requirements of insurance providers for insurance claims of medical procedures provided by the medical practice.

### BACKGROUND OF THE INVENTION

A doctor's office must submit a specific series of individual medical forms for each medical procedure provided over the course of a patient's care. Medical forms include specific documentations from a doctor's medical report in a format that conforms to medico-legal reporting requirements. These documents must contain sufficient details to thoroughly and completely describe a doctor's clinical, diagnostic, and radiographic findings as well as thoroughly and completely describe any completed surgical procedures. The specific individual medical forms required in an insurance claim for a provided medical procedure may be partially or completely defined by the individual insurance provider to which the claim is being submitted. Furthermore, the insurance provider may enforces specific protocols for each individual medical form submitted. As an example, the claim form and content protocols defined and enforced by Center for Medicare & Medicaid Services for medical claim forms are such that even adding a space or hyphen where none is allowed will result in a rejection of the submitted insurance claim. Moreover, claims for different medical procedures often require different accompanying forms. If guidelines for completing medical forms and for required accompanying formation are not followed exactly, claims are consistently rejected even though the claimed procedure is covered under the patient's benefit plan.

As a result, the preparation of individual medical forms is a necessary component of any medical practice which consumes a great deal of time and energy. The doctors and staff within a medical practice often do not know which medical forms are required for a specific type of insurance claim and often are unaware of the specific content protocols which are applied by an insurance provider to those medical forms. This makes generating individual medical forms that much more difficult and the process of successfully filing a medical insurance claim that much more tedious and error prone. The average medical practice, even with experience in generating insurance claims, takes on average twenty to thirty minutes to prepare the medical forms required for a given insurance claim for a specific medical procedure.

The present invention addresses these problems with a system and accompanying methods for fast, accurate and up-date means preparation of individual medical claim forms necessary in insurance claims for specific medical procedures. Specifically, the disclosed embodiments provide a system and accompanying methods to help ensure that an insurance provider's guidelines for claiming specific medical procedures are satisfied. As such, the disclosed system and accompanying methods minimizing the time required to generate and submit medical insurance claims and accompanying documentation necessary to support the medical necessity of a claimed medical procedure. Medical necessity referring to health care activities which can be justified as reasonable, necessary and appropriate based on clinical standards of care. Clinical standards referring to those health care services and supplies provided by a health care provider that are appropriate for the evaluation and treatment of a disease, condition, illness or injury and that are consistent with the applicable standard of care, including the evaluation of experimental and investigational services, procedures, drugs and devices.

### SUMMARY OF THE INVENTION

It is the primary purpose of the disclosed embodiments of the present invention to minimize errors commonly encountered by a medical practice when submitting insurance claims for medical procedures provided to patients over the course of a patient's care.

To accomplish these objectives, according to one embodiment of the present invention, a computer-implemented method for controlling the generation, customization and management of medical documentation forms is provided. The method initially comprising receiving identification information of a current patient and receiving a selection of a medical procedure for the current patient for which a medical insurance claim is to be submitted to a medical insurance provider of the current patient. The method then identifying one or more individual medical forms which are required to support the medical necessity of the selected medical procedure. The method then displaying a sextant image relevant to the selected medical procedure and receiving positional information from a selection made on the displayed sextant image relevant to the provided medical procedure. Lastly, the method generating the identified one or more medical forms such that the generated forms are automatically populated with at least the received identification information and any received positional information.

To accomplish these objectives, according to another embodiment of the present invention a series of instructions on a non-transitory storage medium accessible to a computer is provided, the instructions causing one or more processors within the computer to implement a system of generation, customization and management of medical forms. The system comprising a patient identification information module providing for the inputting, storage and management of patient identification information and a medical procedure selection module providing for the selection of a medical procedure for which a medical insurance claim form is to be generated and submitted to a medical insurance provider. The system further comprising a medical form identification module providing for the identification of one or more individual medical forms required to support the medical necessity of the medical procedure selected within the medical procedure selection module. The system further comprising a sextant image module providing for the display of an image overlaid with selectable positional information and providing for the selection of positional information on the displayed image. Lastly, the system further comprising a medical documentation generation module providing for the generation of one or more individual medical forms identified by the medical documentation identification module, the generated one or more individual medical forms automatically including patient identification information provided by the patient identification information module and positional information provided by the sextant image module.

In addition to the foregoing, other features, objects and advantages of the present invention will become apparent from the following description.

### BRIEF DESCRIPTION OF THE DRAWINGS

The foregoing and other advantages will become apparent from the following detailed description and upon reference to the drawings, wherein:

FIG. 1 illustrates an exemplary network infrastructure for implementing a method of medical form generation, customizing and management according to the present invention;

FIG. 2 illustrates an exemplary computing system for implementing a method of medical form generation, customization and management according to the present invention;

FIG. 3 illustrates an exemplary client graphical user interface for implementing a method of medical form generation, customization and management according to the present invention;

FIG. 4 illustrates an exemplary database graphical user interface for implemented a method of medical form generation, customization and management according to the present invention;

FIG. 5 illustrates an exemplary method for medical form generation, customization and management according to the present invention; and

FIG. 6 further illustrates an exemplary method for medical form generation, customization and management according to the present invention.

### DETAILED DESCRIPTION OF THE INVENTION

The specific systems and methods disclosed in the above-described drawing and the following written description are not presented to limit the scope of the claimed invention. Rather, the drawings and written description are provided to teach a person of reasonable skill in the art to make and use the claimed invention. As such, a person of reasonable skill in the art will appreciate that, for the sake of clarity and understanding, not all features of possibly included in a commercial embodiment of the claimed invention are described.

A person of reasonable skill in the art will also appreciate that the development of a commercial embodiment incorporating aspects of the claimed invention may require numerous implementation-specific decisions. Such implementation-specific decisions may include, but are not limited to, compliance with system, business and governmental related constraints which may vary by specific implementation, location and time. Irrespective of how complex or time-consuming the development of these decisions, such efforts would be a routine undertaking for those of reasonable skill in the art having the benefit of this disclosure.

Particular embodiments of the claimed invention are described with reference to block diagrams and operational illustrations of the claimed systems and methods. It is understood that each block of the block diagrams and operational illustrations may be implemented either by analog hardware, digital hardware or computer program instructions or any combination thereof. The computer program instructions may be executed entirely on a single processor or across multiple processors and as a stand-alone software package or as part of another software package. The one or more processors implementing the computer instructions may be part of a general purpose computer, a special purpose computer, a cloud based system, an application specific integrated circuit or any other know programmable data processing system. Also, in alternate implementations of the claimed invention, the functions, actions, and structures noted in the drawings and the written description may occur out of the order noted in the block diagrams and operational illustrations disclosed herein.

FIG. 1 illustrates an exemplary network infrastructure for implementing a method of medical form generation, customizing and management according to the present invention. As shown in FIG. 1, the exemplary infrastructure 100 includes a computing system 102, a database 104, a local area network 106, a global area network 108, local clients 110 and remote clients 112.

The computing system 102, and methods thereof, provides for the generating, customization and managing of individual medical forms for a variety of medical procedures across a medical practice according to the present invention.

The database 104 is connected to the computing system 102 to provide for the storing, retrieving and categorizing of templates for individual medical forms and of customized versions of individual medical forms previously generated for patients of a medical practice. The database 104 also provides for the storing, retrieving and categorizing of patient identification information. The database may be connected to the computing system 102 either directly, as shown, or indirectly via a network connection.

The local area network 106 provides for a protocol based transfer of data between the local clients 110 and the computing system 102. As such, the local area network 106 provides the local clients 110 access to the method of generating, customizing and managing of individual medical forms implemented by the computing system 102.

The global area network 108 provides for a protocol based transfer of data between at least the remote clients 112 and the computing system 102 via the local area network 106. As such, the global area network 108 provides the remote clients 112 access to the method of generating, customizing and managing of individual medical forms implemented by the computing system 102. The Internet is an exemplary implementation of the global area network 108 of the present invention.

Other suitable global access technologies may also be used to implement the disclosed embodiments without departing from the scope of the invention. As an example, a client/server infrastructure or a cloud based infrastructure may be implemented to provide one or more local and remote clients access to the medical insurance form generation, customization and management system according to the disclosed embodiments.

In one embodiment, the remote users may be individual medical providers who have licensed or otherwise obtained authorization to use the medical insurance form generation, customization and management system implemented by the computing system 102. As such, the computing system 102 may serve as a central repository of individual medical form data and methods thereof which may be accessed by licensed medical providers using a global area network, including a cloud based computing based system. In such an arrangement, authorized users may access the computing system 102 using a computer having only a browser and network capability. Unauthorized access to the computing system 102, and methods thereof, may be prevented by implementing known network security infrastructures and protocols, such as a virtual private network (VPN), firewalls, access lists and the like.

In other embodiments, the computing system 102 may be deployed for local access, such as at the local offices of individual medical providers. In such an arrangement, users may access the computing system 102 either directly from one or more local clients 110 over the local area network 106 or remotely from more remote clients 112 over the global area network 108.

FIG. 2 illustrates an exemplary computing system for implementing a method of medical form generation, customization and management according to the present invention. The computer system may be a personal computer, server, workstation, mainframe or the like. Furthermore, a person of ordinary skill in the art will understand that the computing system 102 may be comprised of a single individual computer or of multiple individual computers working in conjunction with one another.

As shown in FIG. 2, the computing system 200 includes a communication bus 202, main memory 206, read-only memory 208, a processor 204, a communication interface 218 and a storage device 210.

The communication bus 202 provides for the communication of data and instructions between all the components of the computing system 200.

The processor 204 is coupled to the communication bus 202 and provides for the processing of data and execution of instructions within the computing system 200.

The main memory 206, such as random access memory (RAM), is coupled to the communication bus 202 and provides for the temporary storage of dynamic data to be processed by the processor 204 and of computable-readable instructions to be executed by the processor 204.

The read-only memory (ROM) 208 is couple to the communication bus 202 and provides for the persistent storage of static data to be processed by the processor 204 and of computable-readable instructions to the executed by the processor 204.

The storage device 210 is coupled to the communication bus 202 and provides for the non-volatile storage of data and computable readable instructions. The storage device 210 may include, as an example, any magnetic, optical or solid state device accessible to the processor via the communication bus 202.

The communication interface 218 is coupled to the communication bus 202 and provides for two way data communication between the computing system 200 and the local area network 106. For example, the communication interface 218 may be a local or global area network card (NIC) or a wireless network interface card. Regardless of the specific implementation, the main function of the communication interface 218 is to send and receive electrical, electromagnetic, optical, or other signals forms that carry digital data streams representing various types of information.

The term “computer-readable instructions” as used in this disclosure refers to any instructions that may be performed by the processor 204 and/or other components of the computing system 200. Similarly, the term “computer-readable medium” refers to any non-transitory storage medium, such as the storage device 210, which may be used to store data and computer-readable instructions and which may be accessed by the processor 204 to read data and execute those stored instructions.

The computing system 200 may also include a display 212, an input device 214 and a cursor control 216. The display 212, such as a liquid crystal display (LCD), is connected to the communication bus 202 and provides for the intended display of information to a user. The input device 214, such as an alpha numeric keyboard, is connected to the communications bus 202 and provides for the communication of data and command selection by a user to the processor 204. The cursor control 216, such as a mouse, trackball or touch-screen, is connected to the communication bus 202 and provides for the communication of cursor direction and command selection to the processor 204. A person of reasonable skill in the art will understand that other forms of input are possible and covered by these embodiments including touch screens, tablets and voice recognition.

In accordance with the present invention, the medical form generation, customization and management application 220, or more precisely, the computer-readable instructions thereof, may be stored on the storage device 210. The medical form generation, customization and management application 220 may then be executed to allow users to efficiently generate, customize and manage individual medical forms required for an insurance claim.

The medical form generation, customization and management application 220 initially gathers patient identification information, either by a user's direct input or by accessing a patient's profile previously generated and stored on the database 104. The user then selects a medical procedure which has been provided to the current patient for which a medical insurance claim is to be submitted. Based on this selection, the application 220 automatically identifies those individual medical form templates required for a medical insurance claim for the selected medical procedure. The application 220 also allows for the display of a sextant image on which positional information corresponding to the medical procedure may be selected. The user may then select one of the identified individual medical forms and generate a customized version of that selected individual medical form using a stored template of that selected individual medical form. Alternatively, the user may select one of the identified individual medical forms and generate a customized version of that selected medical form using stored individual medical forms generated and customized for other patients who have undergone the same or a similar medical procedure.

FIG. 3 illustrates an exemplary client graphical user interface for implementing a method of medical form generation, customization and management according to the present invention. The exemplary client graphical user interface is displayed on a display connected directly to the computing system 102. Similarly, the client graphical user interface may be displayed on a display connected directly to a local client 110 by an application implemented on the local client 110 that is in communication with the computer system 102 via the local area network 106. Moreover, the client graphical user interface may be a web-based interface displayed on a display connected directly to either a local client 110 or a remote client 112. Although a particular design and layout are shown for the client graphical user interface, one of ordinary skill in the art will recognize that many designs and layouts may be used for the client graphical user interface without departing from the scope of the disclosed embodiments.

As shown in FIG. 3, the client graphical user interface 300 includes a patient information section 310, a select procedure section 320, a forms section 330 and a similar finder section 320.

The patient information section 310 includes a last name field 311, a first name field 312, a subscription ID field 313, a group number field 314, a visit date field 315 and a date of birth field 316. The patient information section 310 further includes a load record button 317, a reset button 318 and a save record button 319.

A user may use these fields to enter a patient's last name, first name, date of birth an visit date. A user may also use these fields to enter the patient's subscription identification number and group number. The subscriber identification number and the group number are the subscriber and patient identifiers, respectively, that appear on the patient's medical insurance card. These identifiers appear on generated insurance forms and other documentation and are used by medical insurance providers to link medical claims and accompanying forms with a specific patient for whom benefits are being requested.

The load record button 317 provides access to client records stored on the database 104 via a database graphical user interface. Using this database graphical user interface, a user may recall a client's record stored on the database 104 and automatically populate the data field 311-316 within the patient information section 310 with the information retrieved from that patient's stored record. The save record button 319 creates a patient record in the database 104 using the information currently in the data fields 311-316 within the patient information section 310. The reset button 318 clears the information in the fields 311-316 within the patient information section 310.

In the select procedure section 320, users may select a medical procedure for which individual medical forms are to be generated. The selection of a medical procedure provides for the automatic identification of those individual medical forms necessary in an insurance claim for the selected medical procedure.

The specific medical procedures listed within the select procedure section 320 may be customized to correspond to a specific medical practice. However, as a general guideline, the listed procedures are those most common to a specific medical practice. The specific individual medical forms automatically identified by the selection of a medical procedure may be determined using several factors. One factor may be actual rules defined by one or more insurance providers as to which medical forms are necessary to establish the medical necessity of a medical procedure for which an insurance claim is to be submitted to an insurance provider.

Another factor may be medical standards defined by a medical regulatory agency or a consortium of medical practitioners which establish which medical forms are necessary to establish the medical necessity of a medical procedure.

Lastly, yet another factor may be the knowledge and experience of a medical practice in preparing and filing medical insurance claims for specific medical procedures. Specifically, a medical practice will have the experience to help define which medical forms are required and what information should be included in those medical forms for a specific medical procedure.

As such, the system and methods of the present invention provide for defining which medical forms are automatically identified for a selected medical procedure using any reasonable source known to one of reasonable skill in the art.

Referring again to FIG. 3, the select procedure section 320 includes medical procedures specific to a dental practice, those procedures including CT Scan, Trauma, Bone Graft, TMD Appliances, Tissue Graft, Cyst Removal, Impacted Teeth and Sleep Apnea. The selection of one of these medical procedures provides for the automatic identification of those individual medical forms which must be generated and submitted with an insurance claim for that selected dental practice medical procedure. As an example, the selection of a bone graft procedure in the select procedure section 320 as shown in FIG. 3 would results in the automatic identification of an operative report, a head and neck evaluation and an LMN bone graft in the forms section 330.

In a general medical practice, as an example, the medical procedures listed within a select procedure section 320 for a general medical practice might include exams, consultations, radiographs, therapeutic procedures, emergency procedures, palliative treatment, sleep apnea appliances and all manner of surgery. Similarly, the selection of one of these medical procedures provides for the automatic identification of those individual medical forms which must be generated and submitted with an insurance claim for that selected general practice medical procedure.

Referring again to FIG. 3, the forms section 330 includes a sextant image portion 332 and an insurance form listing portion 334.

The sextant image portion 332 includes an image corresponding to a medical procedure provided by a medical practice on which may be overlaid selectable positional information. A user may use the provided sextant image to provide specific positional information as to where on a patient a medical procedure was provided. The provided positional information may then be used in the generation of the individual medical forms required to be submitted with an insurance claim for the selected medical procedure.

The use of a sextant image speeds up the process of generating medical forms by simplifying the identification and customization of the appropriate medical forms and claim insurance forms. Specifically, without the use of a sextant, a doctor would have to manually identify surgical or procedural site information from previously generated clinical notes and charting. Furthermore, information from the sextant image allows for searches within the database for processes and surgeries previously performed in the same location. Those results may be used in the generation of medical forms based on previously generated and customized medical forms stored in the database.

As an example, as shown in FIG. 3, the sextant portion 332 for a selected dental medical procedure may be a frontal X-ray of a jaw showing upper and lower rows of teeth within the jaw. Overlaid over the upper row of teeth within the image are selections for the upper right portion (“MxRP”), the upper middle portion (“MxA”) and the upper left portion (“MxLP”). Similarly, overlaid over the lower row of teeth within the image are selections for the lower right portion (“MdRP”), the lower middle portion (“MdA”) and the lower left portion (“MdLP”).

In a general medical practice, the sextant image may be one which helps define the areas of maxillofacial injury, surgery, reconstruction or the presence of pathology or neoplasm that require evaluation or treatment.

As such, the specific image displayed in the sextant portion 332 for a specific medical procedure may be defined using any reasonable source known to one of reasonable skill in the art. Moreover, the specific image displayed in the sextant portion 332 for a specific medical procedure may be customized according a preferences of a medical practice.

Referring again to FIG. 3, the medical documentation listing portion 334 includes a listing of individual medical forms required across the full range of medical procedures provided by a specific medical practice. Next to each listed medical form template is a “create” button 336 which, when selected, causes the generation of a new version of an individual medical form from a template of that corresponding individual medical form stored in the database 104.

As shown in FIG. 3, as an example, the forms listed in the medical documentation listing portion 334 for a dental practice might include an operative report, a head and neck evaluation, a surgical record, a LMN-CT scan, LMN-Implants, a pathology report, a radiology report, a LMN-bone graft, a cyst evaluation, a LMN-TMD TMD report, a LMN-trauma, a LMN-impacted teeth, a LMN-tissue graft and a LMN-sleep apnea. A corresponding template for each of the listed individual medical forms is stored in the database 104.

Once a medical procedure is selected in the select procedure section 320, the individual medical forms required to accompany and support the medical necessity for a selected medical procedure are automatically identified in the medical documentation listing portion 334. As such, a user is automatically alerted as to which individual medical forms must be generated and then submitted with an insurance claim for the selected medical procedure.

As shown in FIG. 3, as an example, once an implant procedure is selected in the select procedure section 320, the operative report, the head and neck evaluation, the LMN-implants and the pathology report are automatically highlighted in the medical documentation listing portion 334. As such, the user is automatically shown which individual medical forms must be generated and then submitted with an insurance claim for an implant. The user can then select the create button 336 next to each of the highlighted individual medical forms to generate that form using a corresponding template stored in the database 104. Alternatively, a user may select a button within the similar finder section 340 corresponding to each of the highlighted individual medical forms to generate a form using a similar individual medical form previously generated, customized and stored in the database for another patient.

Referring again to FIG. 3, the similar finder section 340 includes a similar form selection button section 342, a search keyword field 343, a result listing section 344, a view button 345 and a create similar button 346.

The similar form selection button section 342 provides an individual find button corresponding to each individual medical form listed in the medical documentation listing portion 334 of the forms section 330. As an example, in FIG. 3, the highlighted Operative Report form in the form listing portion 334 has a corresponding Find OP button in the similar selection buttons section 342. Similarly, the highlighted Head & Neck Eval and LMN-Implants forms in the medical form listing portion 334 have corresponding Find H&N and Find LMN-im buttons in the similar selection button section 342. Alternatively, the Pathology Report form in the form listing portion 334 has a corresponding Attach label in the similar selection buttons section 342 as a reminder to attach a corresponding pathology report to an insurance claim.

The result listing section 344 displays the results of a search initiated by the selection of a find button listed within the similar form selection button section 342. As an example, the result listing section 344 displays all previously generated, customized and stored operative reports in the database 104 as a result of selecting the Find OP button listed within the similar form selection button section 342. Similarly, all previously generated, customized and stored head and neck evaluation forms in the database 104 are displayed in the result listing section 344 as a result of selecting the Find H&N button listed within the similar form selection button section 342. Also, all previously generated, customized and saved LMN implant forms in the database 104 are displayed in the result listing section 344 as a result of selecting the Find LMN-Implant button listed within the similar form selection button section 342.

The search keyword field 343 provides for the refinement of the searches performed by each of the find buttons listed within the similar form selection button section 342. As an example, if the word “bilateral” is entered into the search keyword field 343 and the Find OP button within the similar form selection button section 342 is selected, the search result will list all operative reports stored on the database 104 which also contain the word “bilateral” either in the title or in the text of the operative reports.

The View button 345 retrieves from the database 104 and displays the specific medical form selected from those listed in the result listing section 344. The Create Similar button 346 generates a new version of the medical form selected in the result listing section 344. The newly generated medical form is a copy of the form selected from within the result listing section 344 except that the newly generated medical form includes the patient identification information currently in the data fields 311-319 within the patient information section 310 and the sextant information currently defined within the sextant image section 332.

FIG. 4 illustrates an exemplary database graphical user interface for implemented a method of medical form generation, customization and management according to the present invention. The exemplary database graphical user interface is displayed on a display connected directly to the computing system 102. Similarly, the database graphical user interface may be displayed on a display connected directly to a local client 110 by an application implemented on the local client 110 that is in communication with the computer system 102 via the local area network 106. Moreover, the database graphical user interface may be a web-based interface displayed on a display connected directly to either a local client 110 or a remote client 112. Although a particular design and layout are shown for the database graphical user interface, one of ordinary skill in the art will recognize that many designs and layouts may be used for the client graphical user interface without departing from the scope of the disclosed embodiments.

As shown in FIG. 4, the exemplary database graphical user interface 400 includes a search field 410, a keyword field 420, a search button 430, a select field 440, a load button 450, an edit button 460 and a save changes button 470.

The search field 410 allows the user to select which data field is searched in the patient records stored in the database 104. These fields may include any identification information included in the patient information section 310 including last name, first name, data of birth, subscription identification, group number and visit date. Moreover, additional data fields may be defined in patient records and may be used as a search field. As an example, the search field 410 may also include badge number and last modified date fields.

The keyword field 420 allows the user to input the specific data to search for in the data field specified in the search field 410.

The search button 430 initiates a search of patient records stored in the database 104 using the data field selected in the search field 410 and the data entered in the keyword field 420.

The select field 440 displays the results of a search initiated by the search button 430. The select field 440 displays each data field included in a patient record. A user may select a patient from the displayed results and then select the load button 450 to automatically populate the data fields 311-319 within the patient information section 310 with the selected patient's stored identification information.

Alternatively, the user may select the edit button 460 to edit the selected patient's stored record and may then select the save changes button 470 to save those edits to the database 140.

FIG. 5 illustrates an exemplary method for medical form generation, customization and management according to the present invention. Those having ordinary skill in the art will understand that the method 500 represents only one exemplary embodiment and that other methods may be derived without departing from the scope of the disclosed embodiments.

As shown in FIG. 5, the method 500 begins in block 502 with a local user or a remote user accessing the computing system 102. The step of a local user or remote user accessing the computing system 102 may include imputing authentication information required to gain access to the computing system 102 and determining which parts of the database 104 may be accessed by the user.

In blocks 503-505, patient identification information is inputted into the data fields 311-319 within the patent information section 310. As described above, the patient identification information may include the patient's last name 311, first name 312, subscriber identification 313, group number 314, visit date 315 and date of birth 316. In these steps, an existing patients records may be recalled from the database 104 or a new record may be created in the database 104 for a new patient. In both situations, in block 504, the method ensures that sufficient patient information has been entered to properly identify the patient within the database 104.

In blocks 506-508, a medical procedure is selected. The medical procedure selected is one that has been or will be performed on the current patient whose identification information has been inputted and for which an insurance claim may be submitted. As shown in the select procedure section 320 of the illustrative graphical interface 300, a user may select a provided medical procedure from a listing of medical procedures defined for a specific medical practice.

In block 509, the individual medical forms required in an insurance claim for the selected medical procedure are automatically identified. As shown in the forms section 330 of the illustrative graphical interface 300, the one or more required individual medical forms are highlighted within the documentation templates listing portion 334 of the forms section 330. As will be apparent to one of ordinary skill in the art, other comparable means of identifying the individual medical forms may be implemented within the graphical user interface while still being within the scope of the present invention.

In block 510, it is determined whether positional information is required for the selected medical procedure. If positional information is requires, in block 511 a sextant image is automatically selected by the system and displayed in the sextant portion 332 of the forms section 330 of the client graphical user interface 300. Alternatively, a user may manually select an image to display in the sextant portion.

In block 512, the user the user inputs positional information for the selected medical procedure using the image displayed in the sextant portion 332 of the forms section 330.

In block 513, once the sextant information is inputted or if sextant information is not required by the selected medical procedure, an individual medical form listed in the forms section 330 is selected by the user. The selected medical form may be one of the individual medical forms automatically identified as necessary within the medical form listing potion 334 of the forms section 330.

In block 514, the user selects the create button corresponding to a selected individual medical form.

In block 515, the individual medical form corresponding to the selected create button is generated by the computing system 102 using a template for that specific medical form stored in the database 104. The template is automatically populated with the current patient's identification information and, if applicable, current positional information identified on the sextant image.

In block 516, the user may manually further customize the newly generated individual medical form.

Lastly, in block 517, the generated individual medical form is saved with a unique file name to the database 104.

FIG. 6 further illustrates an exemplary method for medical form generation, customization and management according to the present invention. The initial steps in this method are similar to the steps previously described in blocks 502 to 513 of FIG. 5, up to the step of selecting an identified individual medical form.

In block 614, rather than selecting a create button within the forms section 330, the user selects a find button from the similar form selection button section 342 within the similar finder section 340. The selected find button corresponding to a specific medical form listed in the form listing portion 334. The selected find button may be one corresponding to a medical form automatically identified as being necessary in an insurance claim for the selected medical procedure.

In block 615, the system searches the database for stored medical forms similar to the medical form corresponding to the selected find button. The search of the database may be based on any of the standard or customized record fields stored in the database 104. Furthermore, the search may also be based on the actual content within each of the stored medical form files stored in the database. The search terms used are automatically defined based on the selected find button. Moreover, if the user has entered a search term in the keyword field, the search will be based on the combination of the selected find button and the search term entered in the keyword field 343.

In block 616, the system displays the results of this search in the search result listing section 344.

In block 617, the user highlights one of the stored medical forms listed in the search result listing section 344 and selects the view button 345 to review the selected stored medical form.

In block 618, once the users has a found and selected a stored medical form to use to generate the selected individual medical form, the user selects the create similar button 346.

In block 619, the system creates a copy of the selected stored medical form and stores that copy on the database 104 with a new and unique file name. The naming convention of the new file may be based on a number of variables including the patient's name, the medical procedure and the visit date. The newly created medical form retains all previously applied customization relating to the defined medical procedure other than the patient's identification information and positional information.

In block 620, the system automatically amends the newly created medical form to replace that form's patient identification information with current patient identification information defined in the patient information section 310 and to replace the form's positional information with positional information currently defined in the sextant section 332.

In block 621, the user may manually amend the newly created medical form to include any further customization required. This may be necessary to account for differing characteristics between the original patient for whom the original medical form was generated and the current patient for whom a new medical form is being generated based on the original medical form.

Lastly, in block 621, the user saves the customized newly created medical form to the database 104.

In another embodiment of the present invention, statistical medical information is gathered from various locations including medical offices of users of the system. The statistical information may include medical procedure codes for each medical insurance provider, amounts billed for each procedure type and amounts paid of each medical procedure type by each medical insurance provider. The information may be stored in the database and refreshed over one or more variable periods of time. The gathered and stored statistical financial information may be retrieved and processed to provide statistical estimates or predictions of the percentage of the amount billed for each medical procedure that will be paid by each medical insurance provider. The statistical estimates or predictions may be made using any cost estimation method known to be appropriate to those of reasonable skill in the art.

What is claimed:

1. A computer-implemented method for controlling the generation, customization and management of medical forms, the method comprising:
receiving identification information of a current patient;
receiving a selection of a medical procedure for the current patient for which a medical insurance claim is to be submitted to a medical insurance provider of the current patient;
identifying one or more individual medical forms to be submitted with the insurance claim which are required to support the medical necessity of the selected medical procedure;
displaying, if applicable, a sextant image relevant to the selected medical procedure;
receiving positional information from a selection made on the displayed sextant image relevant to the provided medical procedure; and
generating the identified one or more medical forms such that the generated forms are automatically populated with at least the received identification information and any received positional information.

2. The computer-implemented method for controlling the generation, customization and management of medical forms of claim 1 wherein the patient identification information includes the patient's last name, first name, subscription identification, group number, visit date and date of birth.

3. The computer-implemented method for controlling the generation, customization and management of medical forms of claim 1 wherein the sextant image is overlaid with selectable positional information representative of the selected medical procedure.

4. The computer-implemented method for controlling the generation, customization and management of medical forms of claim 1 wherein the required one or more individual medical forms are automatically identified using a standard defined by the medical insurance provider.

5. The computer-implemented method for controlling the generation, customization and management of medical forms of claim 1 wherein the required individual medical forms are automatically identified using a standard defined by the medical practice.

6. The computer-implemented method for controlling the generation, customization and management of medical forms of claim 1 wherein the required individual medical forms are automatically identified using information on the medical insurance claim form to be submitted to the medical insurance provider.

7. The computer-implemented method for controlling the generation, customization and management of medical forms of claim 1 wherein the one or more individual medical forms are generated by retrieving stored templates for each of the identified individual medical forms and customizing the retrieved template to create a new individual medical form representative of the selected medical procedure.

8. The computer-implemented method for controlling the generation, customization and management of medical forms of claim 1 wherein the individual medical forms are generated by retrieving previously generated and stored individual medical forms generated for same or similar medical procedures and customizing the retrieved individual medical forms to create a new individual medical forms representative of the selected medical procedure.

9. The computer-implemented method for controlling the generation, customization and management of medical forms of claim 1 further comprising collecting statistical medical information on medical insurance claims for selected medical procedures previously submitted to one or more medical insurance providers.

10. The computer-implemented method for controlling the generation, customization and management of medical forms of claim 9 wherein the statistical medical information includes medical procedure codes used by the medical providers for a selected medical procedure, amounts billed to the medical insurance provide for a selected medical procedure and amounts paid by the medical insurance providers for a selected medical procedure.

11. The computer-implemented method for controlling the generation, customization and management of medical forms of claim 10 further comprising estimating the percentage of the amount billed that each medical insurance provider will pay for each selected medical procedure.

12. The computer-implemented method for controlling the generation, customization and management of medical forms of claim 1 further comprising generating and automatically populating the medical insurance claim forms to be submitted to the medical insurance provider for the selected procedure.

13. A series of instructions on a non-transitory storage medium accessible to a computer, the instructions causing one or more processors within the computer to implement a system of generation, customization and management of medical forms, the system comprising:
a patient identification information module providing for the inputting, storage and management of patient identification information;
a medical procedure selection module providing for the selection of a medical procedure for which a medical insurance claim form is to be generated and submitted to a medical insurance provider;
a medical form identification module providing for the identification of one or more individual medical forms required to support the medical necessity of the medical procedure selected within the medical procedure selection module;
a sextant image module providing for the display of an image overlaid with selectable positional information and providing for the selection of positional information on the displayed image; and
a medical documentation generation module providing for the generation of one or more individual medical forms identified by the medical documentation identification module, the generated one or more individual medical forms automatically including patient identification information provided by the patient identification information module and positional information provided by the sextant image module.

14. The series of instructions on a non-transitory storage medium accessible to a computer of claim 13 wherein the patient identification information provided by the patient identification information module includes a patient's last name, first name, subscription identification, group number, visit date and date of birth.

15. The series of instructions on a non-transitory storage medium accessible to a computer of claim 13 wherein the sextant image provided by the sextant image module and overlaid with selectable positional information is representative of the medical procedure selected within the medical procedure selection module.

16. The series of instructions on a non-transitory storage medium accessible to a computer of claim 13 wherein the required individual medical forms provided by the medical documentation identification module are automatically identified using a standard defined by the medical insurance provider.

17. The series of instructions on a non-transitory storage medium accessible to a computer of claim 13 wherein the required individual medical forms provided by the medical documentation identification module are automatically identified using a standard defined by the medical practice.

18. The series of instructions on a non-transitory storage medium accessible to a computer of claim 13 wherein the required individual medical forms provided by the medical documentation identification module are automatically identified using information on the medical insurance claim form to be submitted to the medical insurance provider.

19. The series of instructions on a non-transitory storage medium accessible to a computer of claim 13 wherein the individual medical forms generated by the medical documentation generation module are generated by retrieving stored templates for each of the individual medical forms identified by the medical documentation identification module and customizing the retrieved template to create a new individual form representative of the selected medical procedure provided by the medical procedure selection module.

20. The series of instructions on a non-transitory storage medium accessible to a computer of claim 13 wherein the individual medical forms generated by the medical documentation generation module are generated by retrieving previously generated and stored individual medical forms generated for same or similar medical procedures and customizing the retrieved individual medical form to create a new individual form representative of the selected medical procedure provided by the by the medical procedure selection module.

21. The series of instructions on a non-transitory storage medium accessible to a computer of claim 13 further comprising a statistical medical information module for collecting statistical medical information on medical insurance claims for selected medical procedures previously submitted to one or more medical insurance providers.

22. The series of instructions on a non-transitory storage medium accessible to a computer of claim 21 wherein the statistical medical information includes medical procedure codes used by the medical providers for a selected medical procedure, amounts billed to the medical insurance provide for a selected medical procedure and amounts paid by the medical insurance providers for a selected medical procedure.

23. The series of instructions on a non-transitory storage medium accessible to a computer of claim 21 further comprising the statistical medical information module estimating the percentage of the amount billed that each medical insurance provider will pay for each selected medical procedure.
